(19) United States
(12) Patent Application Publication
(10) Pub. No.: US 2026/0051713 A1
(43) Pub. Date: Feb. 19, 2026

(54) SYMMETRIC OPTICAL FIBER LAYOUT TO MITIGATE GROUP DELAY MISMATCH IN MULTI-CORE FIBER

(71) Applicant: Lumentum Operations LLC, San Jose, CA (US)

(72) Inventors: Benedikt HERMANN, Zurich (CH); Mark RUHLE BOSCH, Zurich (CH); Simonette PIERROT, Zurich (CH)

(21) Appl. No.: 18/901,549

(22) Filed: Sep. 30, 2024

Related U.S. Application Data
(60) Provisional application No. 63/684,497, filed on Aug. 19, 2024.

(51) Int. Cl. H01S 3/067; H01S 3/04; H01S 3/042; H01S 3/17

(52) U.S. Cl. CPC H01S 3/06737; H01S 3/0407; H01S 3/042; H01S 3/17

(57) ABSTRACT

A multicore optical fiber includes a fiber medium comprising an input facet configured to receive seed light and an output facet configured to output amplified light; and a plurality of cores arranged in the fiber medium. Each core is configured to guide a respective beamlet of the seed light and includes a respective gain medium for amplifying the respective beamlet into a respective beamlet of the amplified light. The input and output facets are parallel surfaces that point in opposite directions. The fiber medium has a plurality of bends. A number of left-handed bends is equal to a number of right-handed bends such that an integrated bending angle of the fiber medium is zero. Group delays of the plurality of cores are substantially matched as a result of an input-output facet arrangement, and as a result of the integrated bending angle of the fiber medium being zero.

### CROSS-REFERENCE TO RELATED APPLICATION

This patent application claims priority to U.S. Provisional Patent Application No. 63/684,497, filed on Aug. 19, 2024, and entitled “SYMMETRIC OPTICAL FIBER LAYOUT TO MITIGATE GROUP DELAY MISMATCH IN MULTI-CORE FIBER.” The disclosure of the prior application is considered part of and is incorporated by reference into this patent application.

### TECHNICAL FIELD

The present disclosure relates generally to symmetric fiber layouts that mitigate group delay in multi-core fibers.

### BACKGROUND

Active fibers are optical fibers that are doped with rare-earth elements (e.g., erbium, ytterbium, or thulium) inside a fiber core. The rare-earth elements are used as active core materials. Inside the fiber core, the rare-earth element dopants perform a stimulated emission by transforming light (e.g., laser light) into amplified light (e.g., amplified laser light). In some cases, active fibers may be used to generate laser light from pump light. As a result, laser light is generated and/or amplified within the fiber core based on input light. A multicore fiber (MCF) is a fiber containing two or more cores within a single strand. In other words, two or more cores are provided in a same fiber cladding. An MCF with active cores may be used as a power amplifier fiber.

### SUMMARY

In some implementations, a multicore optical fiber includes a fiber medium comprising an input facet configured to receive seed light and an output facet configured to output amplified light; and a plurality of cores arranged in the fiber medium, wherein each core of the plurality of cores is configured to guide a respective beamlet of the seed light and includes a respective gain medium for amplifying the respective beamlet of the seed light into a respective beamlet of the amplified light, wherein the input facet and the output facet are parallel surfaces that point in opposite directions such that a travel direction of the seed light entering the input facet is the same as a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends such that an integrated bending angle of the fiber medium is zero, and wherein group delays of the plurality of cores are substantially matched as a result of an arrangement of the input facet and the output facet, and as a result of the integrated bending angle of the fiber medium being zero.

In some implementations, a coherent beam combining optical fiber includes a fiber medium comprising an input facet configured to receive seed light and an output facet configured to output amplified light; and a plurality of cores arranged in the fiber medium, wherein each core of the plurality of cores is configured to guide a respective portion of the seed light and includes a respective gain medium for amplifying the respective portion of the seed light into a respective portion of the amplified light, wherein the input facet and the output facet are parallel surfaces that face in opposite directions such that a travel direction of the seed light entering the input facet is parallel to a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends, wherein a sum of bending angles of the plurality of bends is zero, wherein left-handed bending angles and right-handed bending angles have opposite signs, and wherein group delays of the plurality of cores are substantially matched as a result of an arrangement of the input facet and the output facet, and as a result of the sum of bending angles being zero.

In some implementations, a coherent beam combining assembly includes a cold plate comprising a groove; and a multicore optical fiber mounted to the cold plate, inside the groove, wherein the multicore optical fiber comprises: a fiber medium comprising an input facet configured to receive seed light and an output facet configured to output amplified light; and a plurality of cores arranged in the fiber medium, wherein each core of the plurality of cores is configured to guide a respective portion of the seed light and includes a respective gain medium for amplifying the respective portion of the seed light into a respective portion of the amplified light, wherein the input facet and the output facet are parallel surfaces that point in opposite directions such that a travel direction of the seed light entering the input facet is the same as a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends such that an integrated bending angle of the fiber medium is zero, and wherein group delays of the plurality of cores are substantially matched as a result of an arrangement of the input facet and the output facet, and as a result of the integrated bending angle of the fiber medium being zero.

### BRIEF DESCRIPTION OF THE DRAWINGS

FIG. 1 shows a coherent beam combining (CBC) assembly according to one or more implementations.

FIG. 2A shows a cross-section of an MCF.

FIG. 2B shows a bending of the MCF in a horizontal plane.

FIG. 3 shows a cross-section of an MCF.

FIGS. 4A and 4B show various example arrangement of MCFs according to one or more implementations.

FIG. 5 shows a fiber assembly according to one or more implementations.

### DETAILED DESCRIPTION

The following detailed description of example implementations refers to the accompanying drawings. The same reference numbers in different drawings may identify the same or similar elements.

Fiber-based amplifiers for ultra-fast lasers are typically limited in achievable peak output powers by nonlinear effects. Intrinsic non-linearities of the active core materials with high peak intensities cause self-phase modulation resulting in a degradation of pulse temporal and spectral properties. One approach to scale ultra-fast fiber amplifiers beyond these limits is to use coherent beam combining (CBC). By spatially multiplexing light through individual cores (or fibers) and utilizing coherent re-combination, peak intensity limits in a single core can be overcome.

“Group delay” refers to the time it takes for a particular group of wavelengths (or a pulse of light) to travel through an optical fiber. In other words, a group delay is a temporal delay experienced by light as the light travels through the optical fiber. Different cores of an MCF may have different group delays leading to group delay differences between the different cores. Group delay differences may be caused by differences in optical path lengths between different channels or cores to be combined (e.g., due to fiber length and/or refractive index variations). Since each core may guide a different beamlet, group delay differences between different cores may result in temporal deviations in arrival time of the different beamlets at the end of the MCF. However, in CBC applications, where the beamlets are re-combined after traveling through the MCF, group delay differences are undesirable and can preclude proper recombination of the beamlets to achieve a peak intensity. For example, for ultra-fast pulses (e.g., ultra-short pulses in a femtosecond to picosecond regime) to be coherently combined efficiently, group delays (arrival time differences) between individual beams or beamlets should be at least one order of magnitude shorter than a pulse length of the individual beams. This level of group delay is required for phase control of individual beams with sub-wavelength precision, resulting in efficient coherent re-combination.

However, bending of an MCF can lead to group delay differences within neighboring cores. If the cores are aligned in a same plane as the bending, a path length difference Δs for two beamlets of neighboring cores is Δs=α×ΔX, where a is a bend angle of the fiber in radians and ΔX is a core separation distance. For example, for a typical U-shaped fiber layout (α=π) and assuming ΔX=100 micrometers (μm), the path length difference is Δs=π×ΔX=314 μm. This path length difference Δs corresponds to a time delay of about 1 picosecond (ps), which is too large to coherently re-combine ultra-fast (sub-picosecond) pulses.

In principle, this time delay mismatch or group delay mismatch would not occur if the bending was orthogonal to the plane of the fibers/cores. However, this phenomenon is achievable only for a linear (e.g., one-dimensional) array of cores. For instance, in a case of horizontal bending, cores arranged along a vertical line will not experience a relative group delay mismatch. However, for any two-dimensional core array (hexagonal grid, rectangular grid, etc.) that includes spatial arrangements of cores along two axes (e.g., a horizontal plane and a vertical plane), bending will cause group delay mismatch between two or more cores. Thus, for any two-dimensional core array, a group delay originating from the fiber layout geometry needs to be controlled to coherently re-combine ultra-fast pulses.

Single fibers with multiple cores (e.g., MCFs) have some advantages for coherent beam combining, compared to multiple independent single-core fibers (SCFs). Since amplifier channels of an MCF have no independent mechanical degree of freedom, sensitivity to vibrations in an MCF is reduced, compared to using multiple independent SCFs. With the core separations mechanically fixed in an MCF, optical coupling into a multi-core fiber can be facilitated with a common set of mirrors, lenses, and diffractive optical elements. In addition, multiple cores of an MCF share a coupled thermal environment, which may reduce potential thermal-variation-caused path length differences.

In experimental demonstrations of CBC, phase control may be dynamically controlled with a feedback loop, during which the group delay is usually considered to be static. In experimental demonstrations, group delay compensation may be performed in various ways, which typically include conventional delay stages. In order to efficiently recombine laser pulses in a CBC system, one coarse tuning method (e.g., a coarse-tuning adjustment knob) may be used to tune the group delay in order to ensure that the pulses temporally overlap, and one fine tuning method (e.g., a fine-tuning adjustment knob) may be used to tune the phase delay to ensure that pulses constructively interfere. However, the coarse tuning method and the fine tuning method required additional components to actively match group delays, which increases complexity and costs of the CBC system.

Some implementations described herein are directed to passively matching group delays of various amplifier channels (e.g., in different fiber cores) in an MCF. The MCF may have a two-dimensional core array. The MCF may include a fiber medium comprising an input facet configured to receive seed light and an output facet configured to output amplified light, and a plurality of cores arranged in the fiber medium. Each core may be configured to guide a respective beamlet of the seed light and may include a respective gain medium for amplifying the respective beamlet into a respective beamlet of the amplified light. The input facet and output facet may be arranged as parallel surfaces that point in opposite directions. As a result, a travel direction of the seed light entering the input facet is the same as a travel direction of the amplified light exiting the output facet. In addition, the fiber medium may have a plurality of bends, including one or more left-handed bends (e.g., counter-clockwise bends) and one or more right-handed bends (e.g., clockwise bends). A number of left-handed bends may be equal to a number of right-handed bends such that an integrated bending angle of the fiber medium is zero. Put another way, a sum of bending angles of the plurality of bends is zero, where left-handed bending angles and right-handed bending angles have opposite signs.

Group delays of the plurality of cores may be substantially matched as a result of an arrangement of the input facet and the output facet (e.g., an input-output facet arrangement), and as a result of the integrated bending angle of the fiber medium being zero. The group delays may be at least one order of magnitude shorter than a pulse duration of the seed light. In other words, any group delay mismatch between the plurality of cores may be at least one order of magnitude shorter than a pulse duration of the seed light. The seed light is pulsed light comprising a plurality of ultra-fast laser pulses with pulse durations in a femtosecond to picosecond regime. In some implementations, each pulse of the plurality of pulses has a pulse duration that is less than 10 picoseconds. For example, the pulse duration of the ultra-fast laser pulses may be in a range of 10 femtoseconds to 10 picoseconds. Here, “pulse duration” refers to a compressed (Fourier-limited) pulse duration, corresponding to chirped pulse amplification. While the actual pulse duration in the amplifier medium might be in a nanosecond regime, for the group delay in a CBC system, the Fourier-limited, compressed (or un-stretched) pulse duration is relevant. By passively matching group delays among the plurality of cores, a correct group delay can be achieved without the need for any additional adjustment knobs or components.

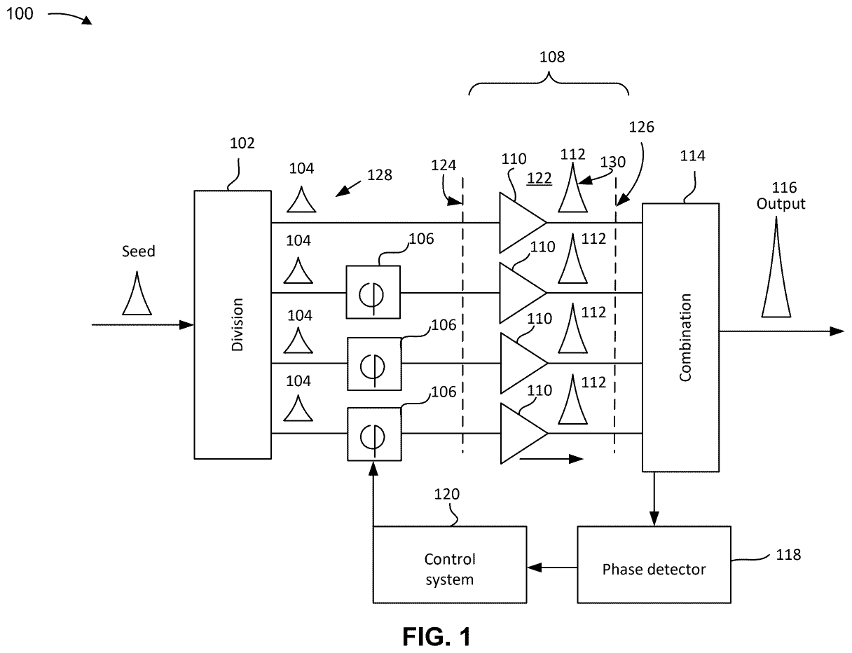

FIG. 1 shows a CBC assembly 100 according to one or more implementations. The CBC assembly 100 includes a divider 102 (e.g., a beam splitter) that divides seed light into respective beamlets of seed light 104, phase modulators 106 (e.g., phase shifters), an MCF 108 having amplifier cores 110 that amplify the respective beamlets of the seed light 104 into respective beamlets of the amplified light 112, and a combiner 114 that combines the respective beamlets of the amplified light 112 into combined, amplified light 116. Additionally, the CBC assembly 100 may further include a phase detector 118 that detects phases of the respective beamlets of the amplified light 112, and a control system 120 that controls the phase modulators 106 such that the phases of the respective beamlets of the amplified light 112 are aligned (e.g., in-phase) based on phase misalignments detected by the phase detector 118.

The MCF 108 may be a CBC optical fiber configured for the CBC assembly 100. The MCF 108 may have a fiber medium 122 that includes an input facet 124 configured to receive the (divided) seed light and an output facet 126 configured to output amplified light (e.g., the beamlets of the amplified light 112). The fiber medium 122 may be doped or may include doped portions for guiding pump light. In some implementations, stress rods may be arranged in the fiber medium 122. The stress rods may be doped with a dopant, such as boron. The amplifier cores 110 may be arranged in the fiber medium 122. Each amplifying core 110 may guide a respective beamlet of the seed light 104 and includes a respective gain medium (e.g., ytterbium) for amplifying the respective beamlet of the seed light 104 into a respective beamlet of the amplified light 112.

The input facet 124 and the output facet 126 may arranged as parallel surfaces that point in opposite directions such that a travel direction of the seed light 104 entering the input facet 124 is the same as a travel direction of the amplified light 112 exiting the output facet 126.

The MCF 108 may have a plurality of bends, including one or more left-handed bends and one or more right-handed bends (not illustrated in FIG. 1). A number of the one or more left-handed bends may be equal to a number of the one or more right-handed bends such that an integrated bending angle of the fiber medium is zero. Put another way, a sum of bending angles of the plurality of bends may be zero, where left-handed bending angles and right-handed bending angles have opposite signs. Thus, the bending angles may be the same or different, as long as the sum of the bending angles equals zero. In some implementations, wherein the fiber medium 122 is not twisted about a longitudinal fiber axis of the MCF 108. In some types of fiber, twisting of the fiber medium 122 may cause group delay mismatches caused by differences in path lengths induced by the twisting.

The MCF 108 may have a symmetry fiber layout such that group delay mismatch between the amplifier cores 110 is substantially zero. In other words, group delays of the amplifier cores 110 may be substantially matched as a result of an input-output facet arrangement of the MCF 108, and as a result of the integrated bending angle of the MCF 108 being zero. The group delays may be at least one order of magnitude shorter than a pulse duration (e.g., the compressed (Fourier-limited) pulse duration) of the seed light. In other words, any group delay mismatch between the amplifier cores 110 may be at least one order of magnitude shorter than a pulse duration of the seed light. For example, as a result of the input-output facet arrangement of the MCF 108, and as a result of the integrated bending angle of the MCF 108 being zero, path lengths of the amplifier cores 110 may be substantially equal such that the group delays are at least one order of magnitude shorter than the pulse duration of the seed light.

The seed light may be pulsed light comprising a plurality of ultra-fast laser pulses 128 with pulse durations in a femtosecond to picosecond regime. In some implementations, each pulse 128 has a pulse duration that is less than 10 picoseconds. For example, the pulse duration of the ultra-fast laser pulses may be in a range of 10 femtoseconds to 10 picoseconds. Here, “pulse duration” refers to a compressed (Fourier-limited) pulse duration, corresponding to chirped pulse amplification. Thus, each respective beamlet of the seed light 104 may include a respective pulse 128 that temporally overlaps with other respective pulses 128 of other respective beamlets of the seed light 104. Since the group delays of the amplifier cores 110 are substantially matched, each respective beamlet of the amplified light 112 may include a respective pulse 130 that temporally overlaps with other respective pulses 130 of other respective beamlets of the amplified light 112. As a result, the symmetry fiber layout may passively match group delays among the amplifier cores 110. By passively matching group delays among the plurality of cores, a correct group delay can be achieved without the need for any additional adjustment knobs or components.

As indicated above, FIG. 1 is provided as an example. Other examples may differ from what is described with regard to FIG. 1. In practice, the CBC assembly 100 may include additional components, fewer components, different components, or differently arranged components than those shown in FIG. 1 without deviating from the disclosure provided above.

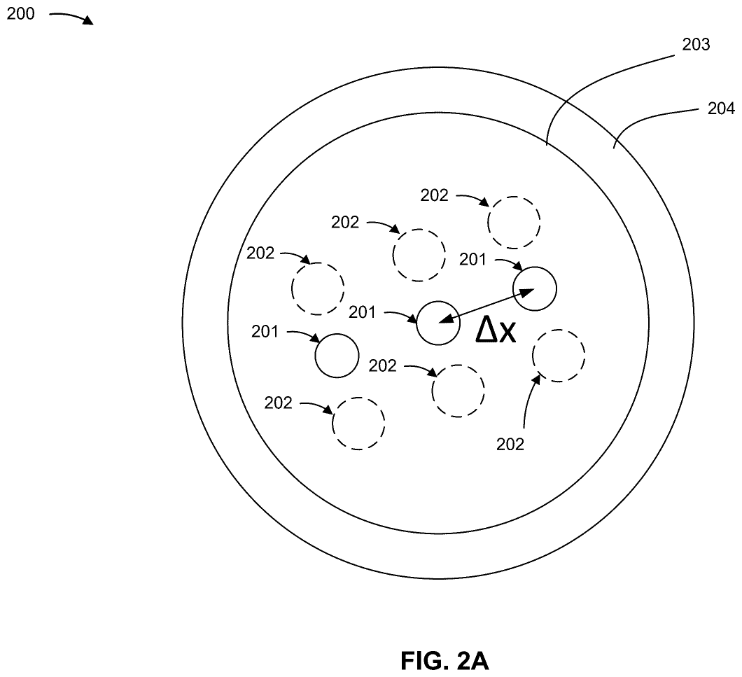

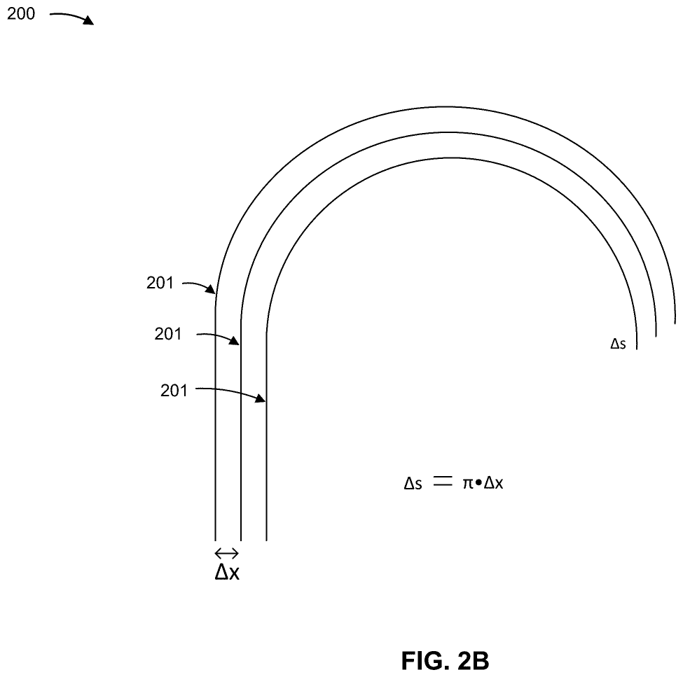

FIG. 2A shows a cross-section of an MCF 200. The MCF 200 may correspond to the MCF 108 described in connection with FIG. 1. The MCF 200 may be a three-core fiber with three cores 201 and six surrounding stress-rods 202 for polarization-maintaining properties. The three cores 201 and six surrounding stress-rods 202 may be arranged in a fiber medium 203, such as glass. The fiber medium 203 may be encircled by a cladding 204. The stress-rods 202 may be arranged in a grid pattern. In addition, each core 201 may be arranged between a respective pair of stress-rods 202. Accordingly, the stress-rods 202 may create birefringence for polarization maintenance of each respective beamlet of the seed light in the cores 201.

As indicated above, FIG. 2A is provided as an example. Other examples may differ from what is described with regard to FIG. 2A. For example, a different number of cores and/or stress rods may be used. Additionally, the cores and the stress rods may be arranging a different pattern than the grid pattern shown in FIG. 2A.

FIG. 2B shows a bending of the MCF 200 in a horizontal plane. A U-shaped, 180-degree bend (e.g., α=π) leads to group delay mismatch. Here, the cores 201 are aligned in the horizontal plane. Thus, FIG. 2B shows an example of a nonsymmetrical fiber layout such that group delay mismatches exceeding an acceptable margin for a CBC system are present.

For example, a path length difference Δs for two beamlets of neighboring cores is Δs=α×ΔX, where a is a bend angle of the fiber in radians and ΔX is a core separation distance. For example, for a typical U-shaped fiber layout (α=π) and assuming ΔX=100 micrometers (μm), the path length difference is Δs=π×ΔX=314 μm. This path length difference Δs corresponds to a time delay of about 1 picosecond (ps), which is too large to coherently re-combine ultra-fast (sub-picosecond) pulses.

Symmetric bending of the MCF 200 in a single plane may mitigate group delay mismatch. The integrated bending angle of the of the MCF 200 should be zero. In other words, the bending of the MCF 200 to a left-hand side and a right-hand side should be balanced. The integrated bending angle may be a sum of all bending angles, with left-hand side and right-hand side bends having opposite signs. This means that an input facet and an output facet of the MCF 200 should be parallel and should be pointed in opposite directions such that a travel direction of light entering the MCF 200 is the same as the travel direction of light exiting the MCF 200, without an unequal number of left-handed loops (or bends) and right-handed loops in the MCF 200. In contrast, a full circle layout may lead to the input facet and the output facet of the MCF 200 pointing in opposite directions, but yielding an unsatisfactory group delay mismatch of 2π×ΔX.

This method for geometrical group delay matching works for any one-dimensional array or two-dimensional array (hexagonal, rectangular grid, etc.) of multiple cores in a single fiber regardless of an orientation of the fiber cross-section of the fiber, provided that the cores maintain a same relative orientation to a mounting plane through an entire length of the fiber. For that reason, twists of the fiber should be avoided in order to ensure identical path lengths for all cores 201. For the three-core (linear) core arrangement corresponding to MCF 200, the stress induced by the stress-rods may provide a preferred bending orientation and may automatically prevent twisting of the MCF 200 during assembly and mounting. However, for other multi-core fiber layouts, twists in the fiber should be prevented during a mounting process. Other multi-core fiber layouts include stress-free non-polarization-maintaining multi-core fibers, as well as polarization-maintaining fibers that may have no preferred bending orientation.

In some implementations, a twisting of the MCF 200 (or another type of MCF) during assembly may be monitored and controlled. Default (e.g., untwisted) orientations of a fiber input (e.g., the input facet) and a fiber output (e.g., the output facet) may be marked on spliced endcaps of the MCF while the MCF is in a stress-free (unbent) state. Orientations of the fiber input and the fiber output may be monitored and maintained during the assembly such that a twisted orientation between the fiber input and the fiber output is prevented. A fine tuning of the fiber orientation to eliminate any residual twist can be done by axial inspection of both endcap facets before final mounting of the endcaps and curing of a glue, which permanently bonds the fiber to a groove of a cold plate. Thus, the cores of the fiber may be maintained in a same relative orientation to the mounting plane through the entire length of the fiber such that path lengths of the cores are matched.

As indicated above, FIG. 2B is provided as an example. Other examples may differ from what is described with regard to FIG. 2B.

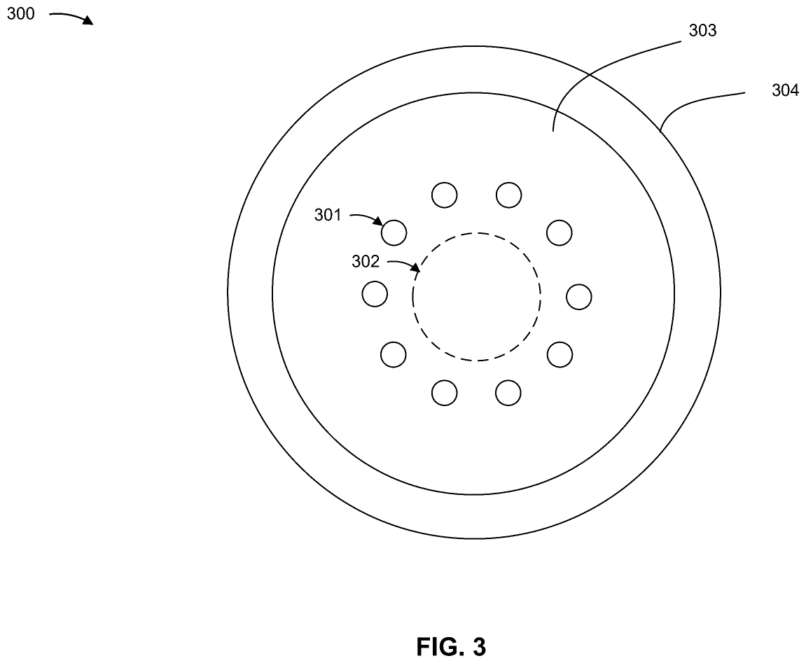

FIG. 3 shows a cross-section of an MCF 300. The MCF 300 may correspond to the MCF 108 described in connection with FIG. 1. The MCF 300 may be a ten-core fiber with ten cores 301 and a central stress rod 302. The ten cores 301 and the central stress rod 302 may be arranged in a fiber medium 303, such as glass. The fiber medium 303 may be encircled by a cladding 304. The central stress rod 302 may be arranged coaxial to a fiber axis of the MCF 300. In addition, the ten cores 301 may be arranged on a circle that is concentric with the central stress rod 302. Thus, the cores 301 may surround the central stress rod 302. Moreover, the cores 301 may be equally spaced from each other on the circle.

The central stress rod 302 may create a circular symmetric stress (and thus birefringence) within the MCF 300 and may make the cores 301 polarization maintaining. Thus, the central stress rod 302 may create birefringence for polarization maintenance of each respective beamlet of the seed light in the cores 301. Due to the circular symmetric stress produced by the central stress rod 302, no preferred bending orientation exists.

Symmetric bending of the MCF 300 in a single plane may mitigate group delay mismatch. The integrated bending angle of the of the MCF 300 should be zero. In other words, the bending of the MCF 300 to a left-hand side and a right-hand side should be balanced. The integrated bending angle may be a sum of all bending angles, with left-hand side and right-hand side bends having opposite signs. This means that an input facet and an output facet of the MCF 300 should be parallel and should be pointed in opposite directions such that a travel direction of light entering the MCF 300 is the same as the travel direction of light exiting the MCF 300, without an unequal number of left-handed loops (or bends) and right-handed loops in the MCF 300.

This method for geometrical group delay matching works for any one-dimensional array or two-dimensional array (hexagonal, rectangular grid, etc.) of multiple cores in a single fiber regardless of an orientation of the fiber cross-section of the fiber, provided that the cores maintain a same relative orientation to a mounting plane through an entire length of the fiber. For that reason, twists of the fiber should be avoided in order to ensure identical path lengths for all cores 301. For the three-core (linear) core arrangement corresponding to MCF 300, the stress induced by the stress-rods may provide a preferred bending orientation and may automatically prevent twisting of the MCF 300 during assembly and mounting. However, for other multi-core fiber layouts, twists in the fiber should be prevented during a mounting process. Other multi-core fiber layouts include stress-free non-polarization-maintaining multi-core fibers, as well as polarization-maintaining fibers that may have no preferred bending orientation.

In some implementations, a twisting of the MCF 300 (or another type of MCF) during assembly may be monitored and controlled. Default (e.g., untwisted) orientations of a fiber input (e.g., the input facet) and a fiber output (e.g., the output facet) may be marked on spliced endcaps of the MCF while the MCF is in a stress-free (unbent) state. Orientations of the fiber input and the fiber output may be monitored and maintained during the assembly such that a twisted orientation between the fiber input and the fiber output is prevented. A fine tuning of the fiber orientation to eliminate any residual twist can be done by axial inspection of both endcap facets before final mounting of the endcaps and curing of a glue, which permanently bonds the fiber to a groove of a cold plate. Thus, the cores of the fiber may be maintained in a same relative orientation to the mounting plane through the entire length of the fiber such that path lengths of the cores are matched.

As indicated above, FIG. 3 is provided as an example. Other examples may differ from what is described with regard to FIG. 3. For example, a different number of cores may be used.

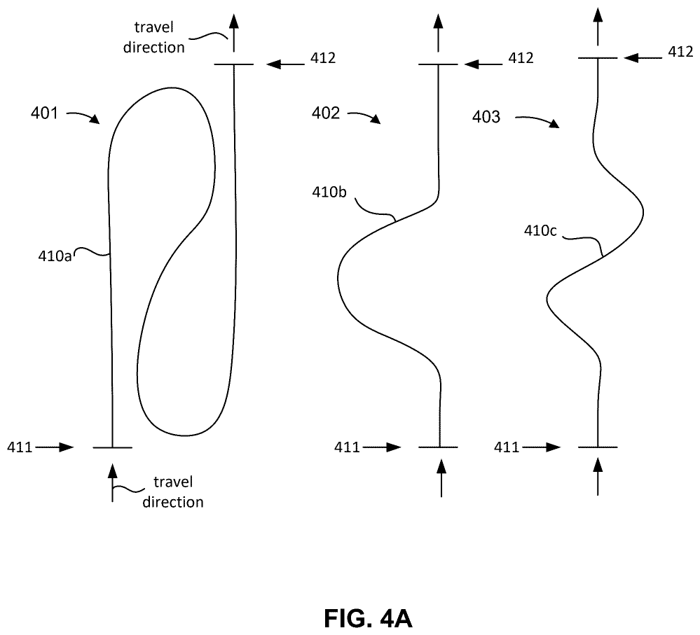

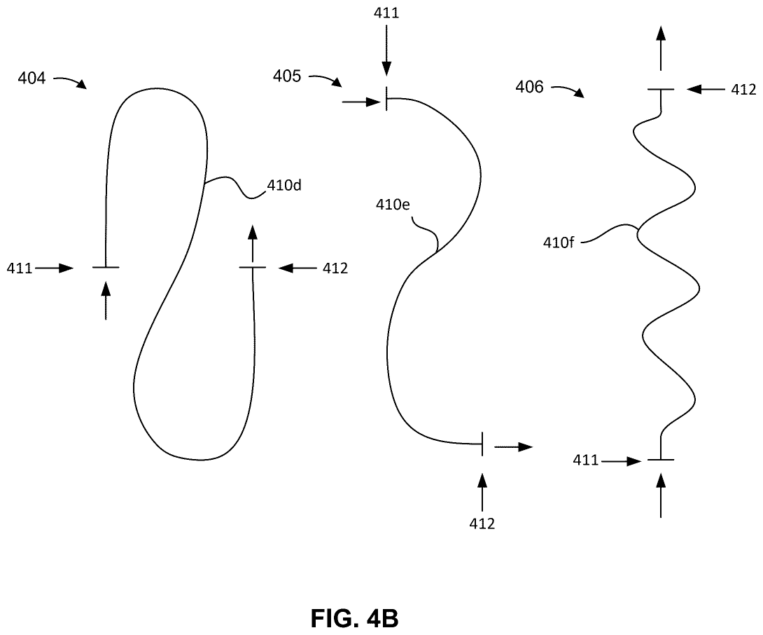

FIGS. 4A and 4B show various example arrangements 401-406 of MCFs 410a-410f, respectively, according to one or more implementations. The example arrangements 401-406 may pertain to arrangements for MCF 200 and MCF 300. The example arrangements 401-406 may fulfill the above-described requirements for symmetric bending that mitigates group delay mismatch between fiber cores of an MCF. For example, the example arrangements 401-406 may include a balanced number of left-hand side and right-hand side bends, with integrated bending angle of each MCF 410a-410f being zero. In addition, an input facet 411 and an output facet 412 of each MCF 410a-410f are arranged parallel to each other and are pointed in opposite directions such that a travel direction of light entering the MCF is the same as the travel direction of light exiting the MCF. The cores of each MCF 410a-410f may be maintained in a same relative orientation to the mounting plane through the entire length of the fibers. A fiber length, a minimal bending radius, and a required footprint may ultimately define which arrangement is favorable. Thus, the example arrangements 401-406 may provide passive, geometry-controlled group delay that mitigates group delay mismatches between cores.

As indicated above, FIGS. 4A and 4B are provided as examples. Other examples may differ from what is described with regard to FIGS. 4A and 4B.

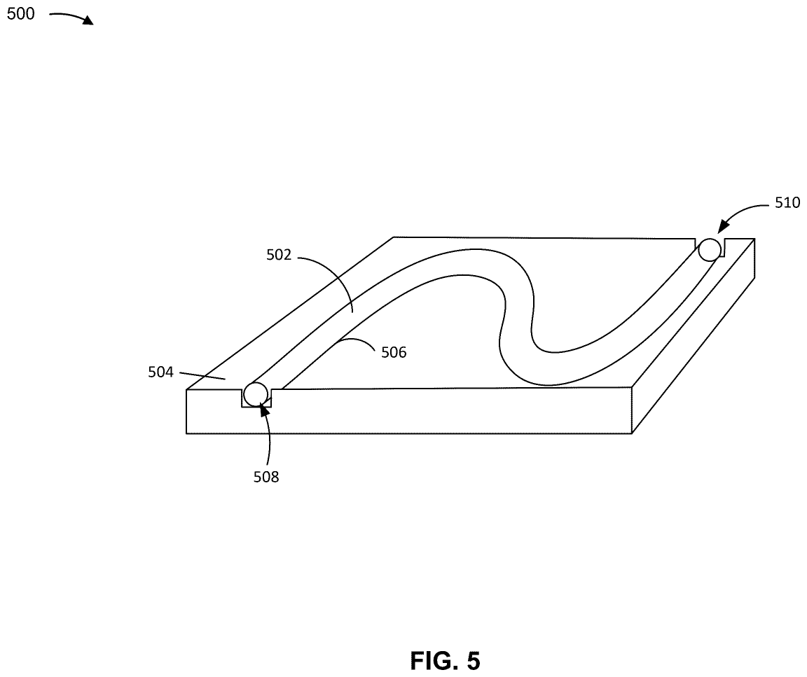

FIG. 5 shows a fiber assembly 500 according to one or more implementations. The fiber assembly 500 may be used in a CBC assembly, such as CBC assembly 100 described in connection with FIG. 1. The fiber assembly 500 may include an MCF 502 and a cold plate 504 comprising a groove 506. The MCF 502 may be mounted to the cold plate 504, inside the groove 506. For example, the MCF 502 may be glued to the cold plate 504, inside the groove 506. Thus, a bending shape of the MCF 502 may be congruent to a shape of the groove 506. The MCF 502 may be similar to the example arrangement 405 shown in FIG. 4B. In addition, the MCF 502 may have an input facet 508 and an output facet 510 that have surfaces arranged parallel to each other and pointed in opposite directions. An integrated bending angle of the groove 506 and the MCF 502 may be zero to mitigate or eliminate group delay mismatches of the cores of the MCF 502. To ensure optimal alignment, spring clamps (not illustrated) may hold the endcaps of the MCF 502 in place on the cold plate 504.

As indicated above, FIG. 5 is provided as an example. Other examples may differ from what is described with regard to FIG. 5.

The following provides an overview of some Aspects of the present disclosure:

Aspect 1: A multicore optical fiber, comprising: a fiber medium comprising an input facet configured to receive seed light and an output facet configured to output amplified light; and a plurality of cores arranged in the fiber medium, wherein each core of the plurality of cores is configured to guide a respective beamlet of the seed light and includes a respective gain medium for amplifying the respective beamlet of the seed light into a respective beamlet of the amplified light, wherein the input facet and the output facet are parallel surfaces that point in opposite directions such that a travel direction of the seed light entering the input facet is the same as a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends such that an integrated bending angle of the fiber medium is zero, and wherein group delays of the plurality of cores are substantially matched as a result of an arrangement of the input facet and the output facet, and as a result of the integrated bending angle of the fiber medium being zero.

Aspect 2: The multicore optical fiber of Aspect 1, wherein the seed light is pulsed light comprising a plurality of ultra-fast laser pulses with pulse durations in a femtosecond to picosecond regime.

Aspect 3: The multicore optical fiber of Aspect 2, wherein the group delays are at least one order of magnitude shorter than a pulse duration of a pulse.

Aspect 4: The multicore optical fiber of any of Aspects 1-3, wherein each respective beamlet of the seed light includes a respective pulse that temporally overlaps with other respective pulses of other respective beamlets of the seed light.

Aspect 5: The multicore optical fiber of any of Aspects 1-4, wherein each respective beamlet of the amplified light includes a respective pulse that temporally overlaps with other respective pulses of other respective beamlets of the amplified light.

Aspect 6: The multicore optical fiber of any of Aspects 1-5, wherein the fiber medium is glass.

Aspect 7: The multicore optical fiber of any of Aspects 1-6, wherein path lengths of the plurality of cores are substantially equal such that the group delays are at least one order of magnitude shorter than a pulse duration of the seed light.

Aspect 8: The multicore optical fiber of any of Aspects 1-7, wherein path lengths of the plurality of cores are equal.

Aspect 9: The multicore optical fiber of any of Aspects 1-8, further comprising: at least one stress rod arranged in the fiber medium, wherein the at least one stress rod creates birefringence for polarization maintenance of each respective beamlet of the seed light.

Aspect 10: The multicore optical fiber of Aspect 9, wherein the at least one stress rod includes a central stress rod arranged coaxial to a fiber axis of the multicore optical fiber, and wherein the plurality of cores are arranged on a circle that is concentric with the central stress rod.

Aspect 11: The multicore optical fiber of Aspect 9, wherein the at least one stress rod includes a plurality of stress rods arranged in a grid pattern, and wherein each core of the plurality of cores is arranged between a respective pair of stress rods.

Aspect 12: The multicore optical fiber of any of Aspects 1-11, wherein the fiber medium is not twisted about a longitudinal fiber axis of the multicore optical fiber.

Aspect 13: A coherent beam combining optical fiber, comprising: a fiber medium comprising an input facet configured to receive seed light and an output facet configured to output amplified light; and a plurality of cores arranged in the fiber medium, wherein each core of the plurality of cores is configured to guide a respective portion of the seed light and includes a respective gain medium for amplifying the respective portion of the seed light into a respective portion of the amplified light, wherein the input facet and the output facet are parallel surfaces that face in opposite directions such that a travel direction of the seed light entering the input facet is parallel to a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends, wherein a sum of bending angles of the plurality of bends is zero, wherein left-handed bending angles and right-handed bending angles have opposite signs, and wherein group delays of the plurality of cores are substantially matched as a result of an arrangement of the input facet and the output facet, and as a result of the sum of bending angles being zero.

Aspect 14: A coherent beam combining assembly, comprising: a cold plate comprising a groove; and a multicore optical fiber mounted to the cold plate, inside the groove, wherein the multicore optical fiber comprises: a fiber medium comprising an input facet configured to receive seed light and an output facet configured to output amplified light; and a plurality of cores arranged in the fiber medium, wherein each core of the plurality of cores is configured to guide a respective portion of the seed light and includes a respective gain medium for amplifying the respective portion of the seed light into a respective portion of the amplified light, wherein the input facet and the output facet are parallel surfaces that point in opposite directions such that a travel direction of the seed light entering the input facet is the same as a travel direction of the amplified light exiting the output facet, wherein the fiber medium has a plurality of bends, including one or more left-handed bends and one or more right-handed bends, wherein a number of the one or more left-handed bends is equal to a number of the one or more right-handed bends such that an integrated bending angle of the fiber medium is zero, and wherein group delays of the plurality of cores are substantially matched as a result of an arrangement of the input facet and the output facet, and as a result of the integrated bending angle of the fiber medium being zero.

Aspect 15: The coherent beam combining assembly of Aspect 14, wherein the seed light is pulsed light comprising a plurality of ultra-fast laser pulses with pulse durations in a femtosecond to picosecond regime.

Aspect 16: The coherent beam combining assembly of Aspect 15, wherein the group delays are at least one order of magnitude shorter than a pulse duration of a pulse.

Aspect 17: The coherent beam combining assembly of Aspect 15, wherein each respective beamlet of the seed light includes a respective pulse that temporally overlaps with other respective pulses of other respective beamlets of the seed light.

Aspect 18: The coherent beam combining assembly of Aspect 17, wherein each respective beamlet of the amplified light at the output facet includes a respective pulse that temporally overlaps with other respective pulses of other respective beamlets of the amplified light.

Aspect 19: The coherent beam combining assembly of Aspect 18, wherein path lengths of the plurality of cores are substantially equal such that the group delays are at least one order of magnitude shorter than a pulse duration of the seed light.

Aspect 20: The coherent beam combining assembly of any of Aspects 14-19, further comprising: at least one stress rod arranged in the fiber medium, wherein the at least one stress rod is configured to induce stress to provide the fiber medium with a preferred bending orientation and automatically prevents twisting of the fiber medium.

Aspect 21: A system configured to perform one or more operations recited in one or more of Aspects 1-20.

Aspect 22: An apparatus comprising means for performing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A multicore optical fiber, comprising:
a fiber medium comprising an input facet configured to receive seed light and an output facet configured to output amplified light; and
a plurality of cores arranged in the fiber medium, wherein each core of the plurality of cores is configured to guide a respective beamlet of the seed light and includes a respective gain medium for amplifying the respective beamlet of the seed light into a respective beamlet of the amplified light,
wherein the input facet and the output facet are parallel surfaces that point in opposite directions such that a travel direction of the seed light entering the input facet is the same as a travel direction of the amplified light exiting the output facet,
wherein the fiber medium has a plurality of bends, including one or more left-handed bends and one or more right-handed bends,
wherein a number of the one or more left-handed bends is equal to a number of the one or more right-handed bends such that an integrated bending angle of the fiber medium is zero, and
wherein group delays of the plurality of cores are substantially matched as a result of an arrangement of the input facet and the output facet, and as a result of the integrated bending angle of the fiber medium being zero.

2. The multicore optical fiber of claim 1, wherein the seed light is pulsed light comprising a plurality of ultra-fast laser pulses with pulse durations in a femtosecond to picosecond regime.

3. The multicore optical fiber of claim 2, wherein the group delays are at least one order of magnitude shorter than a pulse duration of a pulse.

4. The multicore optical fiber of claim 1, wherein each respective beamlet of the seed light includes a respective pulse that temporally overlaps with other respective pulses of other respective beamlets of the seed light.

5. The multicore optical fiber of claim 1, wherein each respective beamlet of the amplified light includes a respective pulse that temporally overlaps with other respective pulses of other respective beamlets of the amplified light.

6. The multicore optical fiber of claim 1, wherein the fiber medium is glass.

7. The multicore optical fiber of claim 1, wherein path lengths of the plurality of cores are substantially equal such that the group delays are at least one order of magnitude shorter than a pulse duration of the seed light.

8. The multicore optical fiber of claim 1, wherein path lengths of the plurality of cores are equal.

9. The multicore optical fiber of claim 1, further comprising:
at least one stress rod arranged in the fiber medium, wherein the at least one stress rod creates birefringence for polarization maintenance of each respective beamlet of the seed light.

10. The multicore optical fiber of claim 9, wherein the at least one stress rod includes a central stress rod arranged coaxial to a fiber axis of the multicore optical fiber, and
wherein the plurality of cores are arranged on a circle that is concentric with the central stress rod.

11. The multicore optical fiber of claim 9, wherein the at least one stress rod includes a plurality of stress rods arranged in a grid pattern, and
wherein each core of the plurality of cores is arranged between a respective pair of stress rods.

12. The multicore optical fiber of claim 1, wherein the fiber medium is not twisted about a longitudinal fiber axis of the multicore optical fiber.

13. A coherent beam combining optical fiber, comprising:
a fiber medium comprising an input facet configured to receive seed light and an output facet configured to output amplified light; and
a plurality of cores arranged in the fiber medium, wherein each core of the plurality of cores is configured to guide a respective portion of the seed light and includes a respective gain medium for amplifying the respective portion of the seed light into a respective portion of the amplified light,
wherein the input facet and the output facet are parallel surfaces that face in opposite directions such that a travel direction of the seed light entering the input facet is parallel to a travel direction of the amplified light exiting the output facet,
wherein the fiber medium has a plurality of bends, including one or more left-handed bends and one or more right-handed bends,
wherein a number of the one or more left-handed bends is equal to a number of the one or more right-handed bends,
wherein a sum of bending angles of the plurality of bends is zero, wherein left-handed bending angles and right-handed bending angles have opposite signs, and
wherein group delays of the plurality of cores are substantially matched as a result of an arrangement of the input facet and the output facet, and as a result of the sum of bending angles being zero.

14. A coherent beam combining assembly, comprising:
a cold plate comprising a groove; and
a multicore optical fiber mounted to the cold plate, inside the groove,
wherein the multicore optical fiber comprises:
a fiber medium comprising an input facet configured to receive seed light and an output facet configured to output amplified light; and
a plurality of cores arranged in the fiber medium, wherein each core of the plurality of cores is configured to guide a respective portion of the seed light and includes a respective gain medium for amplifying the respective portion of the seed light into a respective portion of the amplified light,
wherein the input facet and the output facet are parallel surfaces that point in opposite directions such that a travel direction of the seed light entering the input facet is the same as a travel direction of the amplified light exiting the output facet,
wherein the fiber medium has a plurality of bends, including one or more left-handed bends and one or more right-handed bends,
wherein a number of the one or more left-handed bends is equal to a number of the one or more right-handed bends such that an integrated bending angle of the fiber medium is zero, and
wherein group delays of the plurality of cores are substantially matched as a result of an arrangement of the input facet and the output facet, and as a result of the integrated bending angle of the fiber medium being zero.

15. The coherent beam combining assembly of claim 14, wherein the seed light is pulsed light comprising a plurality of ultra-fast laser pulses with pulse durations in a femtosecond to picosecond regime.

16. The coherent beam combining assembly of claim 15, wherein the group delays are at least one order of magnitude shorter than a pulse duration of a pulse.

17. The coherent beam combining assembly of claim 15, wherein each respective beamlet of the seed light includes a respective pulse that temporally overlaps with other respective pulses of other respective beamlets of the seed light.

18. The coherent beam combining assembly of claim 17, wherein each respective beamlet of the amplified light at the output facet includes a respective pulse that temporally overlaps with other respective pulses of other respective beamlets of the amplified light.

19. The coherent beam combining assembly of claim 18, wherein path lengths of the plurality of cores are substantially equal such that the group delays are at least one order of magnitude shorter than a pulse duration of the seed light.

20. The coherent beam combining assembly of claim 14, further comprising:
at least one stress rod arranged in the fiber medium, wherein the at least one stress rod is configured to induce stress to provide the fiber medium with a preferred bending orientation and automatically prevents twisting of the fiber medium.
